(19) United States
(12) Patent Application Publication
(10) Pub. No.: US 2025/0307693 A1
(43) Pub. Date: Oct. 2, 2025

(54) Real-Time Management of Artificial Intelligence (AI) Input Data/Training Corpus

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); Michael A. Aday, Carollton, TX (US)

(73) Assignee: MICRO FOCUS LLC, WILMINGTON, DE (US)

(21) Appl. No.: 18/620,798

(22) Filed: Mar. 28, 2024

(51) Int. Cl. G06N 20/00

(52) U.S. Cl. CPC G06N 20/00

(57) ABSTRACT

A training scope of an instance of an Artificial Intelligence (AI) algorithm is determined based on a training corpus used to train the instance of the AI algorithm. AI input data is received. The AI input data is input data for the instance of the AI algorithm. A determination is made if some or all of the AI input data is not within the training scope of the instance of the AI algorithm. In response to determining that the some or all of the AI input data is not within the training scope of the instance of the AI algorithm, the some or all of the AI input data is filtered out. The filtered out some or all of the AI input data helps prevent the instance of the AI algorithm from having as many hallucinations.

### FIELD

The disclosure relates generally to the use of AI and particularly to real-time management of input data/training corpuses of AI algorithms.

### BACKGROUND

One of the problems with AI algorithms is that they will try to answer questions that are outside of the training corpus (i.e., a hallucination). Hallucinations can lead to various problems, such as invalid data, which can make the output of the AI algorithm unreliable.

### SUMMARY

These and other needs are addressed by the various embodiments and configurations of the present disclosure. The present disclosure can provide a number of advantages depending on the particular configuration. These and other advantages will be apparent from the disclosure contained herein.

A training scope of an instance of an Artificial Intelligence (AI) algorithm is determined based on a training corpus used to train the instance of the AI algorithm. AI input data is received. The AI input data is input data for the instance of the AI algorithm. A determination is made if some or all of the AI input data is not within the training scope of the instance of the AI algorithm. In response to determining that the some or all of the AI input data is not within the training scope of the instance of the AI algorithm, the some or all of the AI input data is filtered out. The filtered out some or all of the AI input data helps prevent the instance of the AI algorithm from having as many hallucinations.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for real-time management of AI input data and a training corpus.

FIG. 2 is a block diagram of a second illustrative system for filtering AI input data based on a training corpus.

FIG. 3 is a block diagram of a third illustrative system for filtering AI input data based on a user defined training corpus.

FIG. 4 is a block diagram of a fourth illustrative system for creating a new training corpus based on identifying out-of-scope AI input/output data.

FIG. 5 is a block diagram of a fifth illustrative system for creating custom AI algorithms using custom training corpuses.

FIG. 6 is a flow diagram of a process for filtering AI input data based on a training corpus.

FIG. 7 is a flow diagram of a process for determining AI input data that is associated with incorrect output data.

FIG. 8 is a flow diagram of a process for searching a corpus database to generate a training corpus.

FIG. 9 is a flow diagram of a process for using AI input data that is not within a training scope to generate a new training data that is within the training scope.

FIG. 10 is a flow diagram of a process for creating custom AI algorithms as part of an AI as a Service (AIaaS).

FIG. 11 is a flow diagram of a process for creating synthetic training data if there is not enough training data in the training corpus.

FIG. 12 is a flow diagram of a process for getting feedback to produce feedback filter data.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

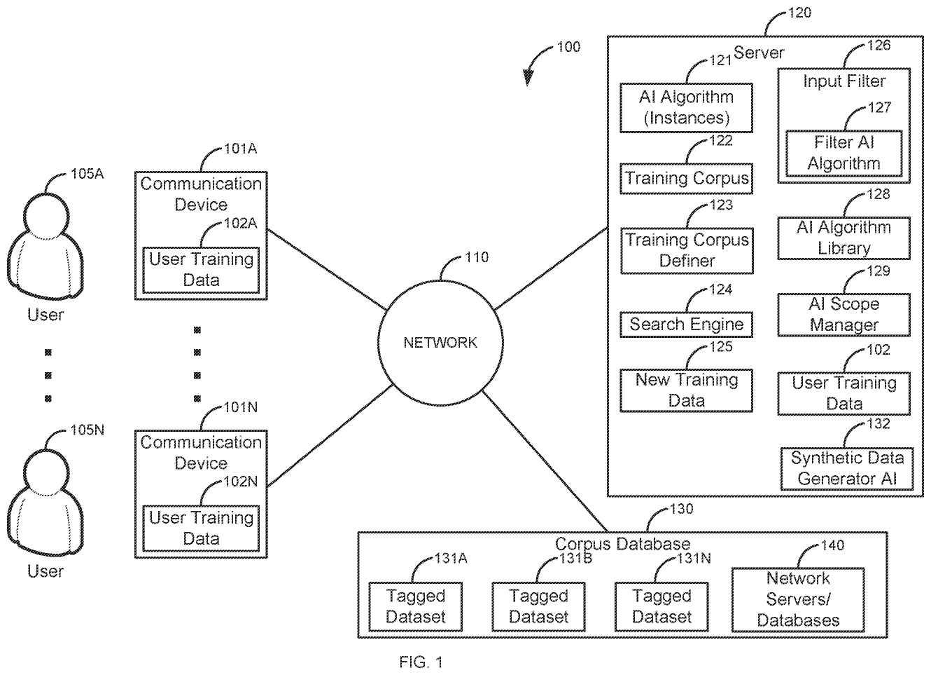

FIG. 1 is a block diagram of a first illustrative system 100 for real-time management of AI input data and a training corpus 122. The first illustrative system 100 comprises communication devices 101A-101N, a network 110, a server 120, and a corpus database 130. In addition, users 105A-105N are shown for convenience.

The communication devices 101A-101N can be or may include any user device that can communicate on the network 110, such as a Personal Computer (PC), a cellular telephone, a Personal Digital Assistant (PDA), a tablet device, a laptop computer, a notebook device, a smartphone, and/or the like. As shown in FIG. 1, any number of communication devices 101A-101N may be connected to the network 110, including only a single communication device 101. The communication devices 101A-101N further comprise user training data 102A-102N.

The user training data 102A-102N is training data that is provided by a user 105 to train the AI algorithm 121. The user training data 102A-102N may be general training data or specific types of training data. For example, the user training data 102A-102N may be image training data, source code training data, document training data, website training data, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The server 120 can be or may include any device that is used to provide AI services. The server 120 may comprise multiple servers/processors to host the AI algorithm 121/instances of the AI algorithm 121. The server 120 comprises the AI algorithm 121, a training corpus 122, a training corpus definer 123, a search engine 124, new training data 125, an input filter 126, an AI algorithm library 128, an AI scope manager 129, a synthetic data generator AI algorithm 132, and the user training data 102.

The AI algorithm 121 may be any type of AI algorithm, such as a supervised AI algorithm, a linear regression AI algorithm, a gradient descent AI algorithm, a random forest AI algorithm, a Naïve Baynes classifier AI algorithm, a Generative Adversarial Neural Network (GANN) AI algorithm, a Large Language Model (LLM) AI algorithm, neural network AI algorithm, and/or the like. The AI algorithm 121 is trained using the training corpus 122.

The training corpus 122 may comprise various types of data depending on the type of AI algorithm 121 and for what purpose the AI algorithm 121 is being trained. The training corpus 122 may comprise general information and/or specific information. For example, the training corpus 122 may only comprise source code. In this example, the AI algorithm 121 is used to generate new source code. The training corpus 122 may comprise some or portions of the user training data 102, the corpus database 130, synthetic training data, and/or the like.

The training corpus definer 123 is used to define what training data will be used in the training corpus 122. The training corpus definer 123 may define what comprises the training corpus 122 based on rules, based on input from an AI algorithm (e.g., the filter AI algorithm 127), based on input from the user 105, and/or the like.

The search engine 124 may be any type of search engine 124 that can search for information associated with a training scope. The search engine 124 may scan/gather any type of data from any type of network 110, such as, the corpus database 130.

The new training data 125 is training data that is generated from a search by the search engine 124. The new training data 125 may be new data that is added to an existing training corpus 122 or may be new data that is used to create a new training corpus 122.

The input filter 126 is used to filter specific AI input data that causes out-of-scope AI output data. For example, if the AI algorithm 121 only has a limited amount of training data in the training corpus 122 for a particular subject, the AI algorithm 121 may provide an incorrect answer (i.e., a hallucination) if the AI input data (AI prompt data) is on the particular subject. The input filter 126 may filter the AI input data based on being trained using the training corpus 122, based on rules, based on input from the filter AI algorithm 127, based on user input, and/or the like.

The input filter 126 further comprises the filter AI algorithm. The filter AI algorithm 127 is trained based on what type of information is in the training corpus 122. The filter AI algorithm 127 uses the information in the training corpus 122 to determine if the AI input data (or a portion of the AI input data) is out-of-scope from the information in the training corpus 122. The filter AI algorithm 127 may also look at output data from the AI algorithm 127/user feedback to further identify AI input data that is out-of-scope in relation to the training corpus 122. For example, if the AI algorithm 121 is hallucinating, the filter AI algorithm 127 can determine AI input data that caused the hallucination.

The AI algorithm library 128 is a library that contains different types of AI algorithms 121. For example, the AI algorithm library 128 may include a random forest AI algorithm, a Naïve Baynes classifier AI algorithm, a Generative Adversarial Neural Network (GANN) AI algorithm, a Large Language Model (LLM) AI algorithm, and/or the like.

The AI scope manager 129 manages the training scope when creating a new instance of a custom AI algorithm 121. The AI scope manager 129 is used to create custom AI algorithms 121 as part of an AI as a Service (AIaaS).

The synthetic data generator AI algorithm 132 is an AI algorithm or process that can be used to generate synthetic training data. The synthetic data generator AI algorithm 132 is used to generate synthetic training data when there is not enough training data for a particular scope of training data in the training corpus 122.

The corpus database 130 may comprise any data/information that can be used as training data for the AI algorithm 121. The corpus database 130 comprises tagged datasets 131A-131N. The tagged datasets 131A-131N have associated metadata that can be used to allow the search engine 124 to efficiently search the tagged datasets 131A-131N. In addition, the corpus database 130 may comprise additional network servers/databases 140. For example, the network servers/databases 140 may be websites on the Internet, source code repositories on the Internet, network-based dictionaries, information databases, private databases, public databases, any device that can host information, and/or the like. Although not shown, the corpus database 130 (or portions thereof) may be hosted on the server 120 and/or on the communication devices 101A-101N.

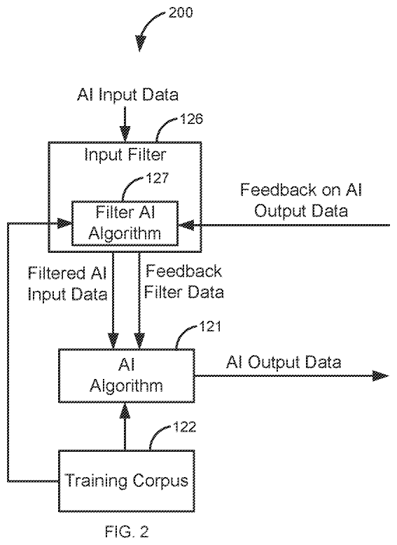

FIG. 2 is a block diagram of a second illustrative system 200 for filtering AI input data based on a training corpus 122. Like the AI algorithm 121, the filter AI algorithm 127 uses the training corpus 122 as training data. However, the filter AI algorithm 127 is trained differently than the AI algorithm 121. The filter AI algorithm 127 is trained in a negative way to identify AI input data that is out-of-scope in relation to the information in training corpus 122. Conversely, the AI algorithm 121 is trained in a positive way to generate results based on the training corpus 122.

Alternatively, or in addition, feedback filter data (prompt data) may be provided to the AI algorithm 121 by the filter AI algorithm 127. The feedback filter data helps to further define specific types of AI output data that the AI algorithm 121 is not supposed to generate. The AI filter algorithm 127 or another process may generate the feedback filter data. For example, feedback from a user 105 may indicate that the AI algorithm 121, as currently trained, cannot reliably produce valid AI output data for a specific type of image; this feedback is then changed, by the filter AI algorithm 127 into feedback filter data that indicates that the AI algorithm 121 is not to generate that specific type of image (a negative feedback filter parameter). The AI input data that is filtered by the input filter 126/filter AI algorithm 127 (filtered AI input data) can then be used in conjunction with feedback filter data to better focus of the AI algorithm 121 to produce valid AI output data.

The filter AI algorithm 127 may also be automatically employed to learn what AI input data causes the AI algorithm 121 to hallucinate. The feedback can then be used to compare the AI input data to those that generate hallucinations (by scanning the AI output data) and filter them out or warn the user 105 that the AI input data or a portion of the AI input data is outside the scope of the training corpus 122 and thus may result in a hallucination. The user 105 can then approve to proceed with the changes or not approve the changes and/or some of the changes.

The filter AI algorithm 127 could be explicitly trained on data that causes hallucinations based on the input data/training corpus 122. This information can then be used to retrain the filter AI algorithm 127 and/or the AI algorithm to not have or allow hallucinations. In addition, hallucinations can be manually flagged and associated with specific information in the training corpus 122/input data. This can be evaluated by the filter AI algorithm 127 to filter out future AI input data that may generate hallucination(s).

The filter AI algorithm 127 can scan the AI output data to determine if there is a hallucination and flag any user input that produces hallucinations. For example, the AI algorithm 121 may look for keywords (e.g., a list of keywords)/data in the AI output data that is outside of the scope of the training corpus 122 and/or use keywords/data (e.g., also a list) that are in-scope. This can then be associated with the corresponding AI input data and learn over time which AI input data causes hallucinations.

The user 105 may be notified that the AI input data is outside the scope of the training corpus 122 and then be given the scope of what the AI algorithm 121 has been trained on. The filter AI algorithm 127 could also identify a subset of the AI input data that may cause the AI algorithm 121 to hallucinate and filter out the subset of AI input data. The subset of the out-of-scope AI input data can also be displayed to the user 105 to allow the user 105 to choose how to manage the out-of-scope AI input data.

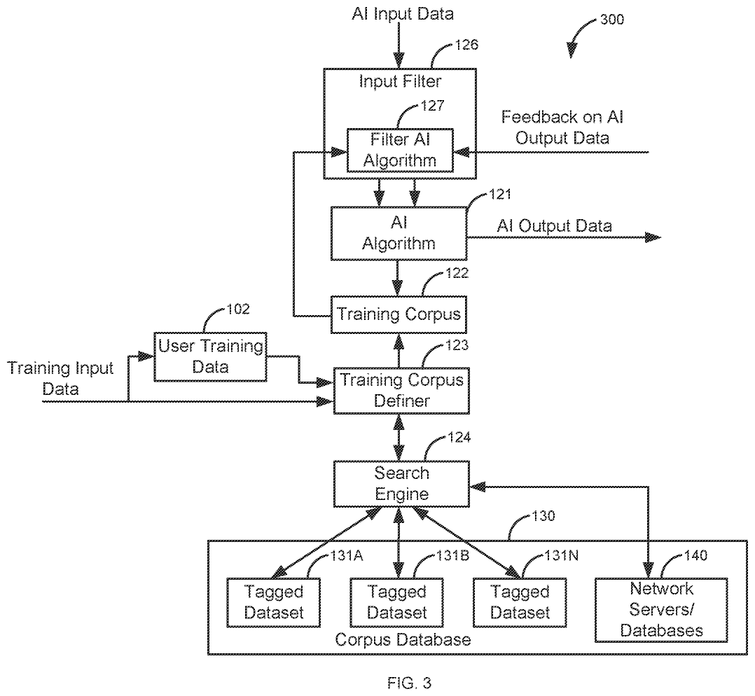

FIG. 3 is a block diagram of a third illustrative system 300 for filtering AI input data based on a user defined training corpus 122. In FIG. 3, the training corpus definer 123 takes user input (training input data) to define the scope of the training corpus 122. The training input data may also comprise the user training data 102.

Based on the training input data/user training data 102, the training corpus definer 123 causes the search engine 124 to scan the corpus database 130 for the appropriate training data and filter out any documents/information that is outside the input training data scope. The corpus database 130 may use metadata to define each of the documents/data in the corpus database 130 so the searching is more efficient. For example, the corpus database 130 may be pre scanned to generate the tagged metadata of the each of the distinct types of tagged datasets 131A-131N. The data gathered by the search engine 124/user training data 102 is used by the training corpus definer 123 to produce the training corpus 122 used to train the AI algorithm 121.

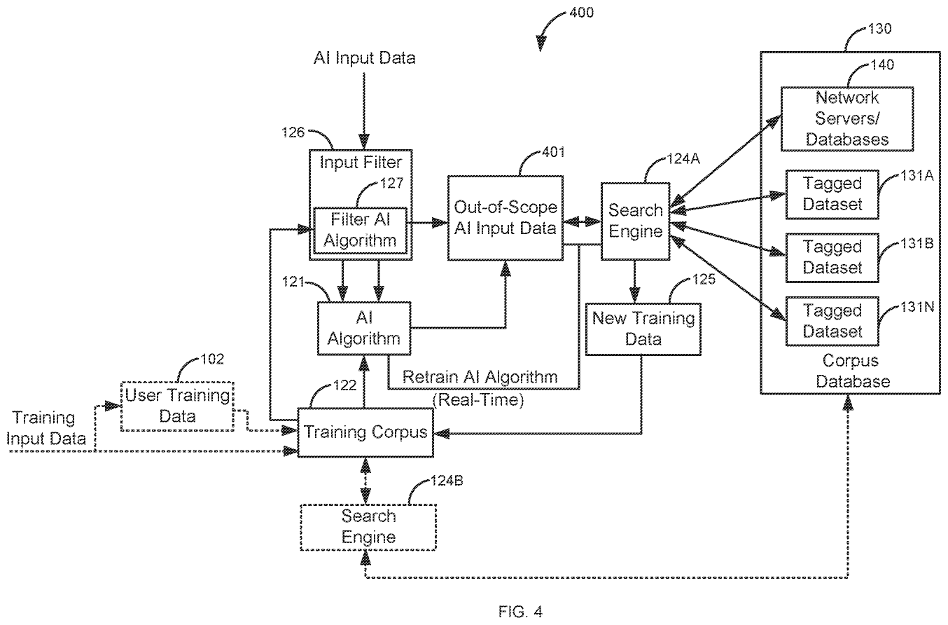

FIG. 4 is a block diagram of a fourth illustrative system 400 for creating a new training corpus 122 based on identifying out-of-scope AI input data 401. If there is AI input data that is outside the scope of the training corpus 121, the filter AI algorithm 127 stores these off. The stored out-of-scope AI input data 401 can be combined with the learned out-of-scope AI input data (those learned based on the AI output data, the user feedback, and/or the like) so that the filter AI algorithm 127 can learn which types of AI input data are out-of-scope. The identified out-of-scope AI input data 401 is then fed into the search engine 124A to look for documents/data in the corpus database 130 that match the out-of-scope AI input data 401. Based on the search, the new training data 125 is generated. The new training data 125 is added to the training corpus 122 and then the AI algorithm 121 is retrained using the training corpus 122 with the new training data 125.

The retraining of the AI algorithm 121 may be based on a threshold. For example, the threshold may be based on a number of out-of-scope AI input data parameters, based on how much new training data 125 is identified, based on a percentage of hallucinations, and/or the like. In addition, the user 105 may be asked to provide the user training data 102 as part of building a new training corpus 122. The retraining may be completed in real-time or at a later time.

One option would be to create a new instance of the AI algorithm 121 (e.g., a second containerized instance) and then train the new instance of the AI algorithm 121 with the new training corpus 122. The system can then switch over to the newly trained AI algorithm (the second instance) and take the previous instance of the AI algorithm 121 offline. This way the AI algorithm 121 is continually reducing hallucinations because the scope of the AI algorithm 121 is dynamically being broadened based the AI input data.

In addition, the user 105 may be given the option of whether to add the new training data 125 to the training corpus 122. The user 105 may also determine if the training is going to occur in real-time, if the training uses another instance and then switches over, if the training will be done out of hours or on a later date, and/or the like.

The process can also work like discussed in FIG. 3 where the initial training corpus 122 is created based in the training input data/user training data 102/search engine 124B. In this case the corpus database 130 is searched to create the initial training corpus 122 and then based on the identified out-of-scope AI input data 401 the initial training corpus 122 may be combined with the new training data 125.

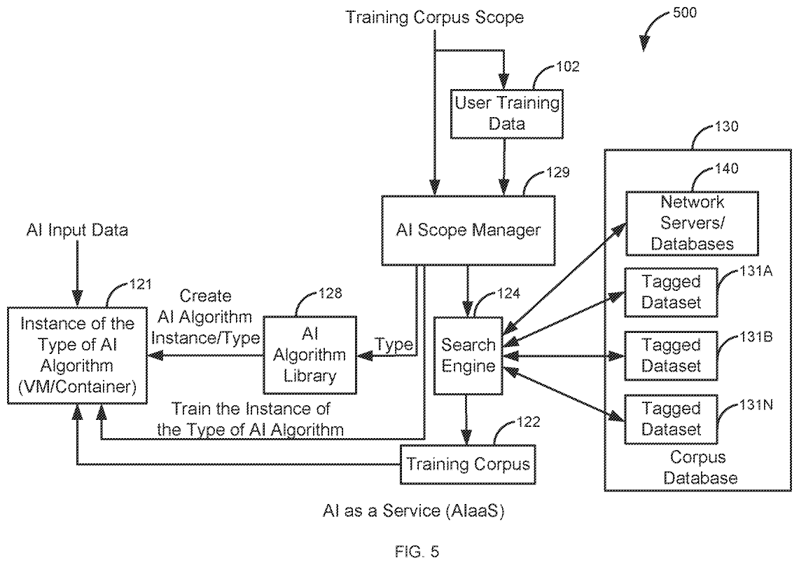

FIG. 5 is a block diagram of a fifth illustrative system 500 for creating custom AI algorithms 121 using custom training corpuses 122. The process of FIG. 5 is part of an AI as a Service (AIaaS). The process of FIG. 5 may be a cloud-based service.

The process starts when the user 105 accesses the AIaaS and defines the scope of the training corpus 122 and the type of AI algorithm 121 to use. As part of the process, the user 105 can also provide the user training data 102. The user training data 102 may be all that is needed and/or data from the corpus database 130 may also be used to generate the training corpus 122.

Once the training corpus scope is determined, if required, the search engine 124 identifies which files/information in the tagged datasets 131A-131N match the training scope requirements. Getting the training data may also include scraping various network servers/databases 140 (e.g., an open-source repository). The user 105 may select which datasets 131A-131N to use based on copyright information, open-source licenses, and/or other factors. For example, if using specific file(s) in the tagged dataset 131 requires a royalty payment, the user 105 may be displayed this information. The user 105 can then opt to use the dataset(s) 131 that requires the royalty payment or not. This training data is then used along with the user provided training data 102 to produce the training corpus 122.

Once the training corpus 122 has been determined, the AI scope manager 129 creates an instance (e.g., a containerized AI Instance or VM AI instance) of the type of AI algorithm (selected by the user 105) from the AI algorithm library 128. For example, the AI algorithm 121 may be a supervised AI learning algorithm, a linear regression AI algorithm, a gradient descent AI algorithm, a random forest AI algorithm, a Naïve Baynes classifier AI algorithm, a Generative Adversarial Neural Network (GANN) AI algorithm, a neural network AI algorithm, and/or the like. Once the instance of the type of AI algorithm 121 is created, the AI algorithm 121 is trained using the training corpus 122. The user 105 can the access and use the newly created/trained AI algorithm 121.

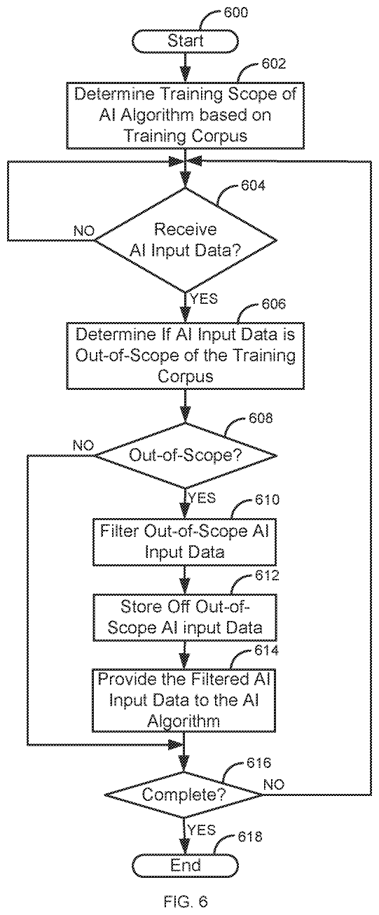

FIG. 6 is a flow diagram of a process for filtering AI input data based on a training corpus 122. Illustratively, the communication devices 101A-101N, the server 120, the AI algorithm 121, the training corpus definer 123, the search engine 124, the input filter 126, the filter AI algorithm 127, the AI scope manager 129, the synthetic data generator AI algorithm 132, and the corpus database 130 are stored-program-controlled entities, such as a computer or microprocessor, which performs the method of FIGS. 6-12 and the processes described herein by executing program instructions stored in a computer readable storage medium, such as a memory (i.e., a computer memory, a hard disk, and/or the like). Although the methods described in FIGS. 6-12 are shown in a specific order, one of skill in the art would recognize that the steps in FIGS. 6-12 may be implemented in different orders and/or be implemented in a multi-threaded environment. Moreover, various steps may be omitted or added based on implementation.

The process starts in step 600. The filter AI algorithm 127 determines, in step 602, the training scope of the AI algorithm 121 based on the training corpus 122. For example, the filter AI algorithm 127 is trained on the training corpus 122 in a negative way to identify out-of-scope AI input data. The input filter 126 waits, in step 604, to receive any AI input data. If there is no AI input data received in step 604, the process of step 604 repeats.

Otherwise, if there is AI input data (e.g., user AI input data) received in step 604, the filter AI algorithm 127 determines if the AI input data is out-of-scope in step 606. If the AI input data is not out-of-scope in step 608, the process goes to step 616. Otherwise, if the AI input data is out-of-scope in step 608, the input filter 126 filters out the out-of-scope AI input data. For example, if the user 105 provides ten different AI input parameters and the filter AI algorithm 127 identifies one of the ten input parameters as being out-of-scope, the one input parameter would be filter out of the AI input data in step 610. The user 105 may be alerted that the input parameter is being filtered out and given the option to allow or not allow the input parameter to be filtered. The filtered-out AI input data is stored off in step 612 and the process goes to step 614. The filtered AI input data (i.e., the nine input parameters) are then provided to the AI algorithm 121 to generate the AI output data in step 614.

The process determines, in step 616, if the process is complete. If the process is not complete in step 616, the process goes back to step 604. Otherwise, if the process is complete in step 616, the process ends in step 618.

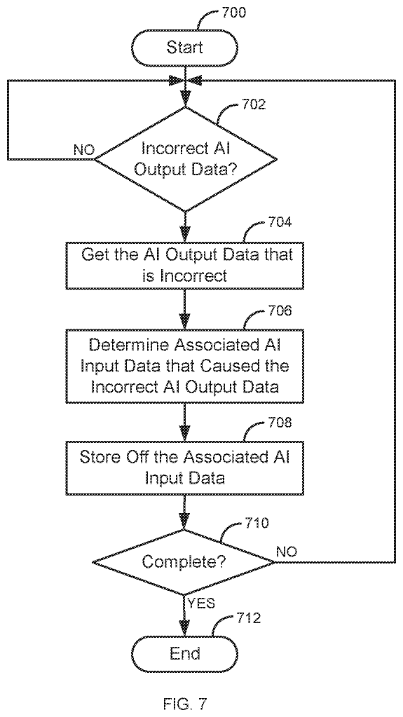

FIG. 7 is a flow diagram of a process for determining AI input data that is associated with incorrect output data. The process starts in step 700. The filter AI algorithm 127 waits, in step 702, for identified incorrect AI output data. The incorrect AI output data may be identified from scanning the AI output data, from word searches, and/or the like. If there is no identified incorrect AI output data in step 702, the process of step 702 repeats.

Otherwise, if there is incorrect AI output data in step 702, the filter AI algorithm 127 gets the incorrect AI output data in step 704. The filter AI algorithm 127 determines, in step 706, the associated AI input data that caused the incorrect AI output data. For example, an input parameter in the AI input data may request to generate a particular type of image. However, if AI output data does not have that particular type of image (e.g., the AI algorithm 121 is not trained to produce that type of image), the filter AI algorithm 127 can identify the specific parameter of the AI input data (to produce the specific type of image) as the associated AI input data in step 706.

The associated AI input data is stored off in step 708. The stored off AI input data may be used in step 610 of FIG. 6 as a filter when the AI algorithm 121 is used in the future. For example, if the AI input data for a future use of the AI algorithm 121 is being reviewed in step 608 as being out-of-scope, this input can be filtered out in step 610. Alternatively, the user 105 may be given the option to filter out the specific type of AI input data.

The process determines, in step 710, if the process is complete. If the process is not complete in step 710, the process goes back to step 702. Otherwise, if the process is complete in step 710, the process ends in step 712.

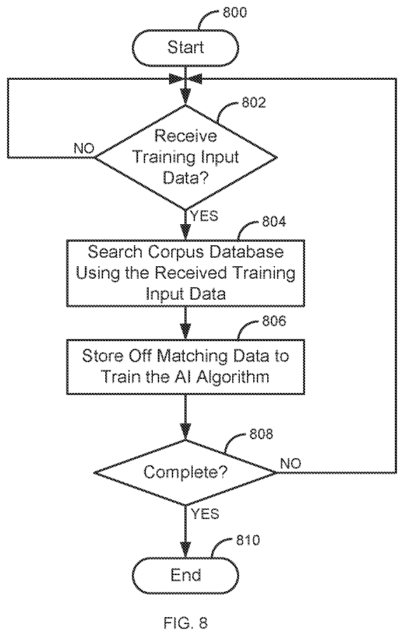

FIG. 8 is a flow diagram of a process for searching a corpus database 130 to generate a training corpus 122. The process of FIG. 8 can be used by the search engine 124 as described in FIG. 3 where the search engine 124 searches the corpus database 130.

The process starts in step 800. The training corpus definer 123 waits, in step 802 to receive the training input data. The training input data includes information about what type of training data will be gathered by the search engine 124 to create the training corpus 122. In addition, the training input data may also comprise the user training data 102.

The search engine 124 searches the corpus database 130 using the received training input data in step 804. The search engine 124 stores off the matching data to train the AI algorithm 121 in step 806. The stored off data of step 806 is combined with the user training data 102 to produce the training corpus 122.

The process determines, in step 808, if the process is complete. If the process is not complete in step 808, the process goes back to step 802. Otherwise, if the process is complete in step 808, the process ends in step 810.

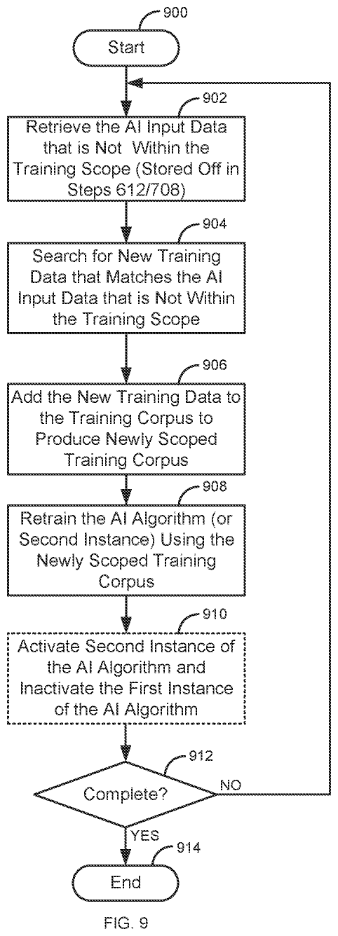

FIG. 9 is a flow diagram of a process for using AI input data that is not within a training scope to generate new training data 125 that is within the training scope. The process of FIG. 9 is used in conjunction with the process described in FIG. 4.

The process starts instep 900. The AI input data that is not within the training scope (e.g., that stored in steps 612 and/or 708) is retrieved in step 902. The search engine 124 searches for new training data 125 that matches the AI input data that is not with the training scope in step 904. The new training data 125 is added to the training corpus 122 to produce a newly scoped training corpus 122 in step 906.

The AI algorithm 121 is retrained, in step 908, using the new training data 125 and the existing training corpus 122. The retraining of the AI algorithm 121 may happen in various ways. If there is only a single instance of the AI algorithm 121, the AI algorithm 121 may be taken off-line and then retrained in step 908. Alternatively, a second instance of the AI algorithm 121 may be retrained while the current instance of the AI algorithm 121 is still running. If there is a second instance of the AI algorithm 121 (indicated by the dotted lines of step 910), the second instance of the AI algorithm 121 is activated and the first instance of the AI algorithm 121 is inactivated in step 910.

The process determines, in step 912, if the process is complete. If the process is not complete in step 912, the process goes back to step 902. For example, if there is a threshold number of AI input data that is not within the training scope, the process may go back to step 902 to create a new training corpus 122. Otherwise, if the process is complete in step 912, the process ends in step 914.

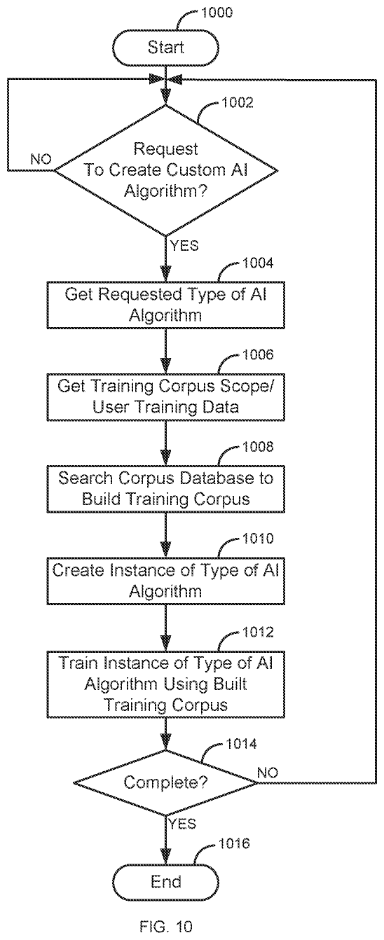

FIG. 10 is a flow diagram of a process for creating custom AI algorithms 121 as part of an AI as a Service (AIaaS). The flow diagram of FIG. 10 is based on the process described in FIG. 5.

The process starts in step 1000. The AI scope manager 129 waits, in step 1002, for a request to create a custom AI algorithm 121. If a request is not received in step 1002, the process of step 1002 repeats.

Otherwise, if there is a request to create a custom AI algorithm 121 in step 1002, the AI scope manager 129 gets the requested type of AI algorithm in step 1004. For example, the requested type of AI algorithm may be a Generative Adversarial Neural Network (GANN) AI algorithm 121. The AI scope manager 129 gets the training corpus scope/user training data 102 in step 1006.

The search engine 124 searches the corpus database 130 to build the training corpus 122 for the custom AI algorithm 121 in step 1008. An instance of the custom AI algorithm 121 is crated in step 1010. The instance of the AI algorithm 121 (the specific type of AI algorithm 121) is trained, in step 1012, using the custom-built training corpus 122. Once trained, the customized AI algorithm 121 can be accessed by the user 105.

The process determines, in step 1014, if the process is complete. If the process is not complete in step 1014, the process goes back to step 1002. Otherwise, if the process is complete in step 1014, the process ends in step 1016.

As part of the AIaaS, the user 105 may select how the user's AI algorithm 121 will be managed/billed. For example, the user 105 may select an option where the user 105 will be billed on a per usage of the custom AI algorithm 121, on an amount of time that the custom AI algorithm 121 is used, a prorated amount based on when the custom AI algorithm 121 is used, processing requirements for the custom AI algorithm 121, memory usage for the custom AI algorithm 121, hardware usage by the custom AI algorithm 121, the AI algorithm type, a size of the training data, a time used to train the AI algorithm 121, and/or the like.

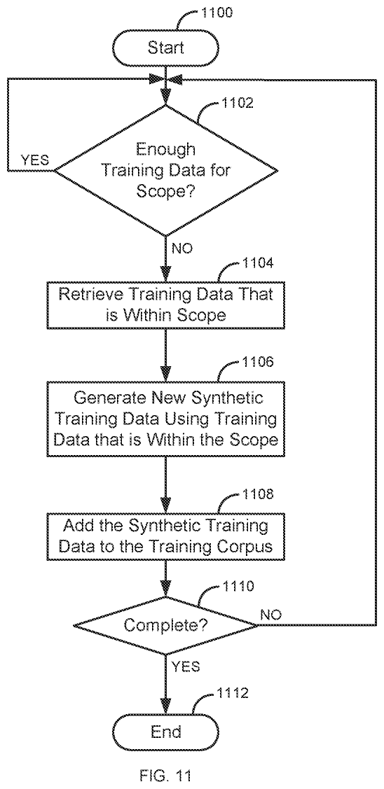

FIG. 11 is a flow diagram of a process for creating synthetic training data if there is not enough training data in the training corpus 122. The process starts in step 1100. The process determines, in step 1102 if there is enough training data in the training corpus 122 for the training scope. The training data in the training corpus 122 may come from various places, such as the user training data 102, training data captured by the search engine 124 from the corpus database 130 (e.g., the new training data 125), and/or the like. Determining if there is enough training data for the scope may be based on a threshold (e.g., a learned threshold). If there is enough training data for the scope in step 1102, the process of step 1102 repeats.

Otherwise, if there is not enough training data for the scope in step 1102, the process gets the training data that is within the scope in step 1104. The synthetic data generator AI algorithm 132 generates new synthetic data using the training data that is within scope in step 1106. The synthetic data generator AI algorithm 132 can use AI input data (prompt data) to create new output data that is within the scope. For example, the AI input data provided to the synthetic data generator AI algorithm 132 may be to produce new images that are of a specific type of image. The new synthetic training data is then added to the training corpus 122 in step 1108.

The process determines, in step 1110, if the process is complete. If the process is not complete in step 1110, the process goes back to step 1102. Otherwise, if the process is complete in step 1110, the process ends in step 1112.

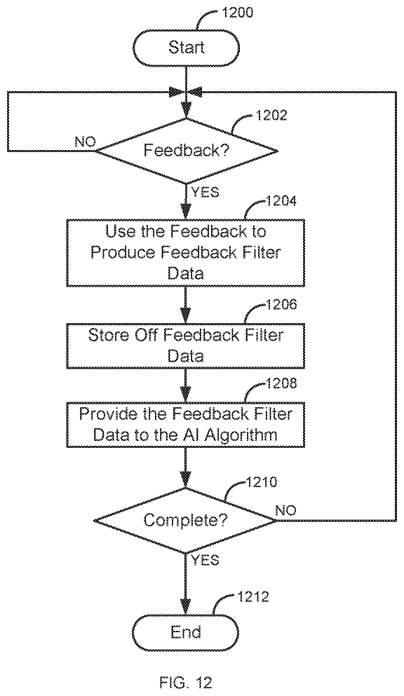

FIG. 12 is a flow diagram of a process for getting feedback to produce feedback filter data. The process starts in step 1200. The filter AI algorithm 127, determines, in step 1202, if there is any feedback. The feedback may be from a user 105 or another source. For example, the feedback may be user feedback that indicates that a specific type of encryption source code cannot be correctly generated by the AI algorithm 121. If there is no feedback in step 1202, the process of step 1202 repeats.

Otherwise, if there is feedback in step 1202, the filter AI algorithm 127 uses the feedback to produce feedback filter data in step 1204. For example, the feedback filter data may be an AI input parameter for the AI algorithm 121 to not generate source code a specific type of encryption source code. The filter feedback data is then stored off in step 1206. The feedback filter data is then provided to the AI algorithm 121 in step 1208. For example, the feedback filter data may be provided to the AI algorithm 121 at the same time the filtered AI input data is provided to the AI algorithm 121 in step 614.

The process determines, in step 1210, if the process is complete. If the process is not complete in step 1210, the process goes back to step 1202. Otherwise, if the process is complete in step 1210, the process ends in step 1212.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
determine a training scope of a first instance of a first Artificial Intelligence (AI) algorithm based on a training corpus used to train the first instance of the first AI algorithm;
receive, first AI input data, wherein the first AI input data is input data for the first instance of the first AI algorithm;
determine if some or all of the first AI input data is not within the training scope of the first instance of the first AI algorithm; and
in response to determining that the some or all of the first AI input data is not within the training scope of the first instance of the first AI algorithm, filter out the some or all of the first AI input data.

2. The system of claim 1, wherein the training scope of the first instance of the first AI algorithm is determined by a second AI algorithm and wherein the second AI algorithm is also trained using the training corpus used to train the first instance of the first AI algorithm, but in a negative manner to identify the some or all of the first AI input data.

3. The system of claim 1, wherein the training scope of the first instance of the first AI algorithm is determined by a second AI algorithm and wherein feedback filter data is generated for use as a negative input to the first AI algorithm.

4. The system of claim 1, wherein the training scope of the first instance of the first AI algorithm is determined by a second AI algorithm and wherein the second AI algorithm scans AI output data from the first AI algorithm to identify additional AI input data that is outside the training scope of the first instance of the first AI algorithm.

5. The system of claim 1, wherein the microprocessor readable and executable instructions further cause the microprocessor to:
receive training input data, wherein the training input data is used to define the training scope of the first instance of the first AI algorithm, wherein the training input data is used to create the training corpus used to train the first instance of the first AI algorithm, and wherein the training corpus used to train the first instance of the first AI algorithm is created based on a search of a corpus database.

6. The system of claim 1, wherein the microprocessor readable and executable instructions further cause the microprocessor to:
provide the some or all of the first AI input data that is not within the training scope to a search engine;
search, using the search engine, for training data that matches the some or all of the first AI input data that is not within the training scope to identify new training data;
add the new training data to the training corpus used to train the first instance of the first AI algorithm to produce a new training corpus; and
retrain a second instance of the first AI algorithm using the new training corpus.

7. The system of claim 6, wherein, upon the second instance of the first AI algorithm being trained using the new training corpus, the second instance of the first AI algorithm becomes active, and the first instance of the first AI algorithm becomes inactive.

8. The system of claim 1, wherein the first instance of the first AI algorithm is selected based on an AI algorithm type as part of an AI as a Service (AIaaS) and wherein the training scope of the first instance of the first AI algorithm is defined when selecting the first instance of the first AI algorithm based on the AI algorithm type.

9. The system of claim 8, wherein the training scope of the first instance of the first AI algorithm is generated based on a search of a corpus database.

10. The system of claim 1, wherein the microprocessor readable and executable instructions further cause the microprocessor to:
determine that the training corpus used to train the first instance of the first AI algorithm does not have enough training data for the training scope;
retrieve training data that is within the training scope of the first instance of the first Artificial Intelligence (AI) algorithm;
generate new synthetic training data that is within the training scope of the first instance of the first AI algorithm; and
add the new synthetic training data to the training corpus used to train the first instance of the first AI algorithm.

11. A method comprising:
determining, by a microprocessor, a training scope of a first instance of a first Artificial Intelligence (AI) algorithm based on a training corpus used to train the first instance of the first AI algorithm;
receiving, by the microprocessor, first AI input data, wherein the first AI input data is input data for the first instance of the first AI algorithm;
determining, by the microprocessor, if some or all of the first AI input data is not within the training scope of the first instance of the first AI algorithm; and
in response to determining that the some or all of the first AI input data is not within the training scope of the first instance of the first AI algorithm, filtering out, by the microprocessor, the some or all of the first AI input data.

12. The method of claim 11, wherein the training scope of the first instance of the first AI algorithm is determined by a second AI algorithm and wherein the second AI algorithm is also trained using the training corpus used to train the first instance of the first AI algorithm, but in a negative manner to identify the some or all of the first AI input data.

13. The method of claim 11, wherein the training scope of the first instance of the first AI algorithm is determined by a second AI algorithm and wherein feedback filter data is generated for use as a negative input to the first AI algorithm.

14. The method of claim 11, wherein the training scope of the first instance of the first AI algorithm is determined by a second AI algorithm and wherein the second AI algorithm scans AI output data from the first AI algorithm to identify additional AI input data that is outside the training scope of the first instance of the first AI algorithm.

15. The method of claim 11, further comprising:
receiving training input data, wherein the training input data is used to define the training scope of the first instance of the first AI algorithm, wherein the training input data is used to create the training corpus used to train the first instance of the first AI algorithm, and wherein the training corpus used to train the first instance of the first AI algorithm is created based on a search of a corpus database.

16. The method of claim 11, further comprising:
providing the some or all of the first AI input data that is not within the training scope to a search engine;
searching, using the search engine, for training data that matches the some or all of the first AI input data that is not within the training scope to identify new training data;
adding the new training data to the training corpus used to train the first instance of the first AI algorithm to produce a new training corpus; and
retraining a second instance of the first AI algorithm using the new training corpus.

17. The method of claim 16, wherein, upon the second instance of the first AI algorithm being trained using the new training corpus, the second instance of the first AI algorithm becomes active, and the first instance of the first AI algorithm becomes inactive.

18. The method of claim 11, wherein the first instance of the first AI algorithm is selected based on an AI algorithm type as part of an AI as a Service (AIaaS) and wherein the training scope of the first instance of the first AI algorithm is defined when selecting the first instance of the first AI algorithm based on the AI type.

19. The method of claim 11, further comprising:
determining that the training corpus used to train the first instance of the first AI algorithm does not have enough training data for the training scope;
retrieving training data that is within the training scope of the first instance of the first AI algorithm;
generating new synthetic training data that is within the training scope of the first instance of the first AI algorithm; and
adding the new synthetic training data to the training corpus used to train the first instance of the first AI algorithm.

20. A non-transient computer readable medium having stored thereon instructions that cause a processor to execute a method, the method comprising instructions to:
determine a training scope of a first instance of a first Artificial Intelligence (AI) algorithm based on a training corpus used to train the first instance of the first AI algorithm;
receive, first AI input data, wherein the first AI input data is input data for the first instance of the first AI algorithm;
determine if some or all of the first AI input data is not within the training scope of the first instance of the first AI algorithm; and
in response to determining that the some or all of the first AI input data is not within the training scope of the first instance of the first AI algorithm, filter out the some or all of the first AI input data.
